(19) United States
(12) Patent Application Publication
(10) Pub. No.: US 2023/0071869 A1
(43) Pub. Date: Mar. 9, 2023

(54) METHOD AND DEVICE FOR SUPPLYING A HEATING PRESS WITH ENERGY AND HEATING PRESS HAVING AN ENERGY SUPPLY DEVICE

(71) Applicant: HARBURG-FREUDENBERGER MASCHINENBAU GMBH, Hamburg (DE)

(72) Inventors: Jörn SEEVERS, Barum - St. Dionys (DE); Fokko ERDMANN, Adendorf (DE)

(21) Appl. No.: 17/800,060

(22) PCT Filed: Feb. 4, 2021
(86) PCT No.: PCT/DE2021/100109

§ 371 Date: Aug. 16, 2022

(30) Foreign Application Priority Data
Feb. 18, 2020 (DE) 10 2020 104 231.0

(51) Int. Cl. H01M 8/04007; B29C 43/04; B29C 43/52; B29D 30/06; B30B 15/34

(52) U.S. Cl. CPC H01M 8/04007; B29C 43/04; B29C 43/52; B29D 30/0662; B30B 15/34; B29D 2030/067; B29D 2030/0674

(57) ABSTRACT

A method and the device serve to supply a heating press with electrical energy. At least one fuel cell is used. In particular, the fuel cell is located in a tire heating press or in close proximity to the tire heating press.

The invention relates to a method for supplying a heating press with electrical energy.

In addition, the present invention relates to a device for supplying a heating press with energy.

In particular, the invention also relates to a heating press which is equipped with a device for supplying energy.

Typically, heating presses for producing tires in the area of production halls are connected to a system for supplying electrical energy. In addition, the heating presses are often also connected to a system for supplying heating steam.

According to the prior art, tire heating presses are often equipped with various heating systems, which have to ensure the required heating of the mold and of the green tire for the vulcanization of the green tire. The heating of the mold and of the green tire takes place in this case by the supply of a heated thermal medium, in particular hot steam, and/or by electrical heating devices.

In the area of automotive engineering, so-called fuel cells are currently already in widespread use. Such fuel cells are capable of generating electrical energy directly from a fuel, typically hydrogen, a hydrocarbon or a mixture of hydrocarbons. Such fuel cells are suitable in particular for mobile applications and also for local energy generation.

An object of the present invention is to improve a method of the type mentioned at the beginning in such a way as to assist in autonomously supplying a heating press with energy, in particular a tire heating press.

A further object of the present invention is to provide a device for supplying a tire heating press with energy and also to equip a tire heating press with a corresponding device.

The aforementioned objects are achieved by using at least one fuel cell.

In one embodiment of the invention, a heating press has at least one fuel cell.

The fuel required for converting the chemical reaction energy into electrical energy can be stored for use in the at least one fuel cell in a corresponding storage device, such as for example a tank.

In one embodiment of the invention, the storage device for at least one fuel is part of the heating press.

In a further embodiment of the invention, the storage device for at least one fuel is not part of the heating press and is connected by suitable lines to the at least one fuel cell.

In one embodiment of the invention, at least some of the heating devices are designed as an electrical heating device.

In one embodiment, at least some of the heating devices are designed as a thermal-medium heating device, with which it is possible to heat a thermal medium from which thermal energy can be transmitted to a green tire and/or to components or subassemblies of the heating press that are to be heated.

In a preferred embodiment of the invention, the thermal medium of a thermal-medium heating device can be heated to a temperature required for the vulcanization of a green tire.

In one embodiment of the invention, the thermal medium of a thermal-medium heating device can be heated up to a temperature in a range from approximately 150° C. to 210° C.

In a preferred embodiment of the invention, the thermal medium of a thermal-medium heating device can be heated up to a temperature in a range from approximately 120° C. to 200° C., in particular of approximately 160° C. to 200° C.

In one embodiment of the invention, at least some of the heating devices are designed as a steam heater, with which a thermal medium taking the form of hot steam can be fed into the region of an object to be heated and/or a component or a subassembly to be heated of the heating press and the object and/or the component or the subassembly can be heated thereby.

In one embodiment of the invention, at least some of the heating devices are designed as an electrical heater and at least some others of the heating devices are designed as a thermal-medium heater.

In one embodiment of the invention, at least some of the heating devices are designed as an electrical heater and at least some others of the heating devices are designed as a steam heater.

In one embodiment of the invention, the internal heater of the heating press for a green tire is designed as a thermal-medium heater.

In one embodiment of the invention, the internal heater of the heating press for a green tire is designed as a steam heater.

In one embodiment of the invention, the mold heater of the heating press is designed as an electrical heater.

In one embodiment of the invention, the at least one fuel cell is designed and can be used for generating at least part of the electrical energy which the heating devices designed as electrical heating devices require for heating the respectively assigned object and/or component of the heating press.

In a preferred embodiment of the invention, the at least one fuel cell is designed and can be used for generating the entire electrical energy which the heating devices designed as electrical heating devices require for heating the respectively assigned object and/or component of the heating press.

In one embodiment of the invention, the exhaust gas of the at least one fuel cell can be used for heating at least some of the objects to be heated and/or components or subassemblies to be heated of the heating press.

In one embodiment of the invention, the fuel cell is designed in such a way that steam occurs as exhaust gas of the fuel cell, so that the steam can be used directly or after a further temperature increase for heating an assigned object and/or component or subassembly of the heating press.

In one embodiment of the invention, it is designed as a tire heating press and has an internal heater for a green tire to be vulcanized, in the case of which the heating of the green tire is realized with the aid of the exhaust gas of the at least one fuel cell.

In one embodiment of the invention, it has a heat exchanger, with which thermal energy can be transmitted from the exhaust gas of the at least one fuel cell to the thermal medium of a thermal-medium heater.

In one embodiment of the invention, it has a thermal-medium store, in which a heated thermal medium can be stored.

In one embodiment of the invention, the thermal-medium store is designed as a hot-water store, in which hot water or steam can be stored.

In one embodiment of the invention, it has a thermal-medium store designed as a thermal-medium accumulator, in which thermal medium can be stored under pressure.

In one embodiment of the invention, the thermal-medium accumulator is designed as a hot-water accumulator, in which hot water can be stored at a pressure of 10 bar to 20 bar.

In a preferred embodiment, water can be stored in the hot-water accumulator at a pressure of approximately 15 bar.

In one embodiment of the invention, the thermal medium in the thermal-medium store can be heated up to approximately 170° C.

In one embodiment of the invention, the water in the hot-water store can be heated up to approximately 170° C.

In a preferred embodiment of the invention, the heating of the thermal-medium store takes place by using the electrical energy generated with the aid of the at least one fuel cell and/or the exhaust gas generated with the aid of the at least one fuel cell.

In one embodiment of the invention, the thermal-medium store is designed as a bladder accumulator, allowing a controlled buildup of pressure.

In one embodiment of the invention, the thermal medium that is fed to the thermal-medium store can be heated with the aid of the at least one fuel cell before being fed into the thermal-medium store.

In one embodiment of the invention, the internal heater of the tire heating press for at least one green tire is designed as a thermal-medium heater, which has at least one thermal-medium store.

In one embodiment of the invention, the internal heater of the tire heating press for at least one green tire is designed as a steam heater, which has at least one hot-water store.

In one embodiment of the invention, the heated thermal medium of the thermal-medium heater can be directed out of the thermal-medium store into a bladder, which can be expanded inside a green tire and by way of which the thermal energy of the heated thermal medium can be transmitted to the green tire.

In one embodiment of the invention, the hot steam of the steam heater can be directed out of the hot-water store into a bladder, which can be expanded inside a green tire and by way of which the thermal energy of the hot steam can be transmitted to the green tire.

In one embodiment of the invention, the cooled thermal medium can be returned into the thermal-medium store.

In one embodiment of the invention, the cooled steam and/or condensed water can be returned into the hot-water store.

In one embodiment of the invention, the cooled thermal medium can be heated up with the aid of the at least one fuel cell.

In one embodiment of the invention, the cooled steam and/or condensed water can be heated up with the aid of the at least one fuel cell.

In one embodiment of the invention, a mixture of water or steam and nitrogen is used as the thermal medium.

In one embodiment of the invention, the electrical energy generated with the aid of the at least one fuel cell can be used for supplying the control electronics and/or electrical drives of a heating press.

In one embodiment of the invention, it has a storage device for electrical energy, in which energy generated with the aid of the at least one fuel cell can be stored.

In one embodiment of the invention, the storage device for electrical energy is designed as a rechargeable battery.

In a method according to the invention for supplying a heating press with energy, in one method step electrical energy is generated with the aid of at least one fuel cell. In a further method step, the energy generated with the aid of the at least one fuel cell is used for supplying at least some of the electrical heating devices of the heating press. In a further method step, at least some of the components or subassemblies to be heated of the heating press for a vulcanization of a green tire are heated with the aid of the electrical heating devices.

In one embodiment of a method according to the invention for supplying a heating press with energy, at least one thermal medium is used for heating at least some of the components or subassemblies to be heated of the heating press for a vulcanization of a green tire.

In one embodiment of a method according to the invention for supplying a heating press with energy, in one method step a thermal medium is heated with the aid of at least one fuel cell to a temperature in a range from 120° C. to 210° C., preferably in a range from 150° C. to 210° C., particularly preferably in a range up to 200° C.

In a preferred embodiment of a method according to the invention for supplying a heating press with energy, in one method step a thermal medium is heated with the aid of at least one fuel cell to a temperature of approximately 170° C.

In one embodiment of a method according to the invention for supplying a heating press with energy, the thermal medium is heated by using the exhaust gas produced by the at least one fuel cell.

In one embodiment of a method according to the invention for supplying a heating press with energy, the exhaust gas of the at least one fuel cell is used at least as part of the thermal medium.

In one embodiment of a method according to the invention for supplying a heating press with energy, the thermal medium heated with the aid of the at least one fuel cell is used for the internal heater of the heating press.

In one embodiment of a method according to the invention for supplying a heating press with energy, the heated thermal medium is stored in an accumulator.

In one embodiment of a method according to the invention for supplying a heating press with energy, the thermal medium is directed out of the accumulator through a suitable system of lines to an internal heater of the heating press, where the thermal medium transmits part of its thermal energy to at least one object to be heated and/or to a component to be heated or a subassembly to be heated of the heating press.

In one embodiment of a method according to the invention for supplying a heating press with energy, after it has transmitted part of its thermal energy to at least one object to be heated and/or a component to be heated or a subassembly to be heated of the heating press, the thermal medium is returned by way of a suitable line into the accumulator.

In one embodiment of a method according to the invention for supplying a heating press with energy, once it has transmitted part of its thermal energy to at least one object to be heated and/or a component to be heated or a subassembly to be heated of the heating press and before being returned into the accumulator, the thermal medium is heated with the aid of the at least one fuel cell.

In one embodiment of a method according to the invention for supplying a heating press with energy, the electrical energy generated with the aid of the at least one fuel cell is used for supplying the control electronics and/or electrical drives of a heating press.

In one embodiment of a method according to the invention for supplying a heating press with energy, at least part of the electrical energy generated with the aid of the at least one fuel cell is stored in a storage device for electrical energy.

In one embodiment of a method according to the invention for supplying a heating press with energy, water or steam is used as the thermal medium.

An exemplary embodiment of the invention is schematically represented in the drawing, in which:

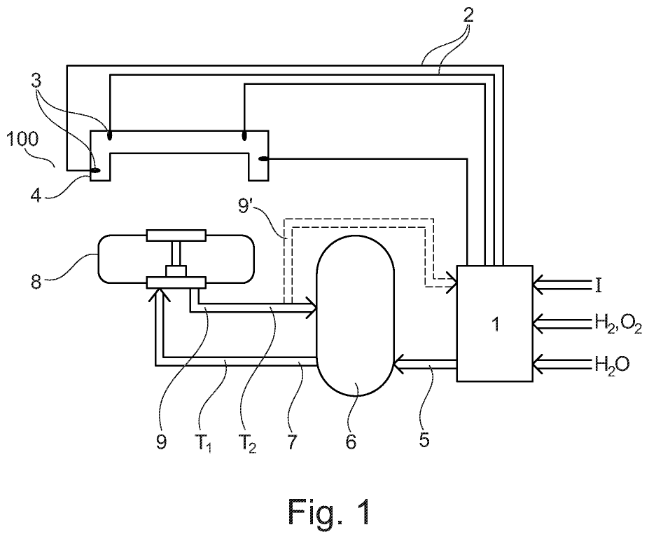

FIG. 1: shows a schematic representation to illustrate a tire heating press having a fuel cell.

FIG. 1 shows a schematic representation of a detail of a heating press (100) according to the invention, which is designed as a tire heating press. The heating press (100) has a fuel cell (1), to which, for the generation of electrical energy by way of electrical current (I), the reaction partners required for the function of the fuel cell (1) (provided by way of example by H₂ and O₂) and water (H₂O) can be fed.

The electrical energy that can be generated with the aid of the fuel cell (1) can be directed by way of suitable cables (1) to electrical heating devices (3). The electrical heating devices (3) represented are arranged in the region of a mold (4) of the heating press (100), so that the mold (4) can be heated with the aid of the electrical heating devices (3).

Furthermore, water can be heated with the aid of the fuel cell (1). The heated water is connected by way of a feed line (5) to a hot-water store (6), which is designed as a hot-water accumulator.

The hot water can be transported in the form of steam at a temperature T₁ by way of a supply line (7) into the region of an internal heater (8) for a green tire to be vulcanized. In the embodiment represented, the internal heater (8) has an expandable bladder, into which the hot steam can be introduced.

From the hot steam, thermal energy can be transmitted through the bladder to a green tire to be vulcanized, so that the temperature of the steam falls to a temperature T₂. The steam and/or condensate produced can subsequently be directed with the aid of a return line (9) into the hot-water store (6).

In an alternative embodiment of the invention, the steam and/or condensate produced can be directed out of the region of the internal heater (8) with the aid of a return line (9′), represented by dashed lines, into the region of the fuel cell (1) and can be heated there, before it is returned into the hot-water store (6).

As an alternative or in addition to the use of the electrical energy generated by the fuel cell for supplying an electrical heating element that is explained above by way of example, it is also possible to use the electrical energy for supplying electrical actuators in the region of the heating press with energy and/or for supplying an electrical or electronic control of the machine with energy. The actuators already mentioned may for example be used in the region of handling devices. Electrical feeding of drive motors is likewise envisaged.

As likewise already mentioned, the fuel cell may be integrated in mechanical engineering terms in the construction of the heating press. However, it is likewise possible to arrange the fuel cell in the region of a separate supply unit and just to connect the supply unit electrically to the heating press.

As likewise already mentioned, the fuel cell may be realized according to various structural design principles. The fuel cell obtains the electrical energy by the oxidation of an oxidizable chemical substance. This may be for example hydrogen gas, but any carbon-containing gases or carbon-containing liquids are likewise conceivable. The fuel cell is preferably operated at ambient temperature, but operating temperatures above ambient temperature are also possible in principle. The ambient temperature typically lies in a range from −30 to +60° C.

Depending on the specific technical way in which the fuel cell is realized, a gas or liquid is obtained as the oxidation product.

As an alternative to the oxidation of substances already mentioned, it is also possible in principle to use fuel cells which generate electrical energy by other chemical reactions between at least two substances and/or by chemical conversions of at least one substance.

1-14. (canceled)

15. A device for supplying a heating press with energy, comprising at least one fuel cell.

16. The device according to claim 15, wherein the heating press is a tire heating press.

17. The device according to claim 15, wherein the fuel cell is arranged in a region of a unit separate from the heating press.

18. The device according to claim 15, wherein the heating press includes heating devices, wherein the at least one fuel cell supplies electrical energy and/or thermal energy to at least some of the heating devices.

19. The device according to claim 18, wherein at least one of the heating devices is an electrical heating device that is supplied with electrical energy via the at least one fuel cell.

20. The device according to claim 18, wherein at least one of the heating device is a thermal-medium heater that is supplied with thermal energy via the at least one fuel cell.

21. The device according to claim 18, wherein at least one of the heating devices is a thermal-medium heater that has a thermal medium heated by exhaust gas of the at least one fuel cell.

22. The device according to claim 18, wherein at least one of the he devices is a thermal-medium heater, exhaust gas of the at least one fuel cell being used at least as part of the thermal medium of the thermal-medium heater.

23. A heating press comprising at least one fuel cell for generating electrical energy.

24. A method for supplying a heating press with electrical energy, comprising the step of using at least one fuel cell to supply electrical energy to the heating press.

25. The method for supplying a heating press with electrical energy according to claim 24, including generating electrical energy using the at least one fuel cell, supplying the energy generated using the at least one fuel cell to at least some electrical heating devices of the heating press, and heating at least some components or subassemblies of the heating press for a vulcanization of a green tire using the electrical heating devices.

26. The method for supplying a heating press with electrical energy according to claim 24, including heating a thermal medium of at least one thermal-medium heater of the heating press using the at least one fuel cell.

27. The method for supplying a heating press with electrical energy according to claim 26, including using exhaust gas of the at least one fuel cell for heating the thermal medium of the at least one thermal-medium heater of the heating press.

28. The method for supplying a heating press with electrical energy according to claim 24 including using a device for supplying energy that includes the at least one fuel cell.
